(19) United States
(12) Patent Application Publication
(10) Pub. No.: US 2018/0025440 A1
(43) Pub. Date: Jan. 25, 2018

(54) ONLINE DATING AND SOCIAL NETWORKING SYSTEM

(71) Applicant: HEREKITTYKITTY LLC, Jenison, MI (US)

(72) Inventors: David Wheeler, Hudsonville, MI (US); Jacob Thompson, St. Charles, IL (US)

(21) Appl. No.: 15/647,478

(22) Filed: Jul. 12, 2017

Related U.S. Application Data
(60) Provisional application No. 62/366,295, filed on Jul. 25, 2016.

(51) Int. Cl. G06Q 50/00; G06F 17/30

(52) U.S. Cl. CPC G06Q 50/01; G06F 17/30386; G06F 17/30867; G06Q 99/00

(57) ABSTRACT

The present invention provides an online dating and social networking system for identifying compatible users to other users. The system comprises a network of users, wherein each user must complete a user profile to be searchable and contactable by other users in the system. In one embodiment, the user profile comprises at least one negative image or description of the user. The system further comprises a process for identifying compatible users.

### CROSS-REFERENCE TO RELATED APPLICATIONS

This application claims priority to U.S. Provisional Application No. 62/366,294 filed Jul. 25, 2016, which is hereby incorporated by reference in its entirety for all purposes.

### FIELD OF THE DISCLOSURE

This disclosure relates generally to an online dating and social network and more specifically to a user profile for use in an online dating and social network system.

### BACKGROUND

Digital technology and smartphones in particular have transformed many aspects of our society, including how people seek out and establish relationships, professionally, romantically and socially. For instance, 1 in 3 relationships begin using a dating product, and millions more Americans use websites and mobile apps to make connections both professionally and socially. Millions of Americans view online dating and social networks as a good way to meet new people.

Most online dating and social networking websites and mobile apps require a user to prepare a user profile including an image or picture, a physical description (such as height, body type, and other various physical attributes), a personality description and a self-summary. It's not uncommon for users to exaggerate or lie in their profiles, under pressure to survive in a highly competitive dating environment. In fact, 53% of online daters have lied in their dating profiles and 81% admit to misrepresenting themselves. Sophisticated online users have come to distrust the veracity of most user profiles, which could account for why over one-third of online daters never actually go on a real-life date with someone identified using an online dating program.

Accordingly, there is a need for an improved, more accurate user profile for use with online dating and social networking systems that encourages a more accurate, trustworthy “real-life” profile of each user.

### SUMMARY OF THE INVENTION

The invention provides an online dating and social networking system for identifying compatible users to each other, the system comprising a network of users, wherein each user completes a user profile to be searchable and contactable by other users in the system, wherein the user profile comprises at least one negative image of the user; and a process for identifying compatible users. In one embodiment, the user profile further comprises a positive image of the user. In an alternate embodiment, the user profile further comprises at least one positive characteristic about the user. In an alternate embodiment, the user profile further comprises at least one negative characteristic of the user.

In an alternate embodiment, the user profile consists of at least one flattering image of the user; at least one unflattering image of the user; at least one positive characteristic about the user; and at least one negative characteristic of the user. In an alternate embodiment, the user profile further comprises at least one characteristic the user “would settle for” in a compatible user.

The invention also provides a user profile for identifying compatible users online in a dating and social networking system consisting of at least one unflattering image of the user. In an alternate embodiment, the user profile further comprises at least one negative characteristic of the user. In an alternate embodiment, the user profile further comprises at least one positive or flattering image of the user. In an alternate embodiment, the user profile further comprises at least one positive characteristic of the user.

The invention also provides a method for identifying compatible users of an online dating and social networking system to each other, the method comprising supporting a network of users; requiring each user to complete a user profile, wherein the user profile comprises at least one flattering image of the user; or at least one unflattering image of the user; or at least one positive characteristic about the user; or at least one negative characteristic of the user; and identifying compatible users to each other based on the user profile. In an alternate embodiment, the user profile consists of at least one unflattering image of the user; or at least one negative characteristic of the user. In an alternate embodiment, the user profile consists of at least one unflattering image of the user; and at least one negative characteristic of the user. In an alternate embodiment, the user profile consists of an unflattering image of the user; at least one negative characteristic of the user; and at least one positive characteristic of the user. In an alternate embodiment, the user profile consists of at least one flattering image of the user; at least one unflattering image of the user; at least one positive characteristic about the user; and at least one negative characteristic of the user.

The invention also provides an online dating and social networking system for identifying compatible users to each other, the system comprising a network of users, wherein each user completes a user profile to be searchable and contactable by other users in the system, wherein the user profile comprises at least one negative characteristic of the user; and a process for identifying compatible users. In an alternate embodiment, the user profile further comprises at least one positive image of the user. In an alternate embodiment, the user profile further comprises at least one positive characteristic about the user. In an alternate embodiment, the user profile further comprises at least one negative image of the user. In an alternate embodiment, the user profile consists of at least one flattering image of the user; at least one unflattering image of the user; at least one positive characteristic about the user; and at least one negative characteristic of the user.

Unless defined otherwise, all technical terms have the same meanings as commonly understood by one of ordinary skill in the art to which this disclosure belongs. Further, alternative descriptions which are similar or equivalent to the methods and techniques described are also protected by this disclosure. The terminology used is for description of the embodiments only and should not be construed as limiting of the disclosure as a whole.

Other objects, features and advantages of the present disclosure will become apparent after review of the attached claims and drawings.

### BRIEF DESCRIPTION OF THE DRAWINGS

FIG. 1 shows a sample user profile.

FIG. 2 shows an alternative embodiment of a sample user profile.

FIG. 3 shows an alternative embodiment of a sample user profile.

FIG. 4 shows an alternative embodiment of a sample user profile.

FIG. 5 shows an alternative embodiment of a sample user profile.

FIG. 6 shows an alternative embodiment of a sample user profile.

FIG. 7 shows an alternative embodiment of a sample user profile.

### DETAILED DESCRIPTION OF THE INVENTION

The present invention provides an online dating and social networking system for identifying compatible users to each other. The system comprises a network of users, wherein each user must complete a user profile to be searchable and contactable by other users in the system. In one embodiment, the user profile comprises at least one negative image or characteristic of the user. The system further comprises a process for identifying compatible users.

By “system” we mean an Internet-based network of users who can access information about other users based on reciprocal compatibility. The system may be accessed and supported by at least one centralized computer server that maintains the processes and databases for a number of different users, or it may represent a distributed set of computers located in different geographic regions, each serving a different group of users. The system may be accessed by a user using means known to the art, including, for example, through a website or software application of the website for use on handheld, wireless computing devices, such as smartphones and tablets.

By “users” we mean individuals who join the system in an effort to find other users who appear compatible, or who appear worth learning more about.

By “compatible” we mean the user-identified specific criteria or information that the user considers interesting enough to investigate further for a romantic or social relationship. The compatible criteria can include interest-based, location-based, or reciprocal compatibility between users.

By “identifying” we mean that the system may use methods and algorithms known to the art to sort information provided by a user to identify other users that may be compatible with a specific user. The system alerts a user to potential compatible users of the system, and may also rank such potentially compatible users for the user to investigate further. When a potentially compatible user is identified by the system, the system may, in some embodiments, inform the user of the potentially compatible user so as to allow the user to initiate communication with the potentially compatible user identified.

In use, the system may be accessed by a user through a computer website or mobile application. The premise of the system acknowledges that nobody is perfect and that honesty and realism are important in any relationship. In the following description, numerous specific details are introduced to provide a thorough understanding of, and enabling description for, embodiments of the system. One skilled in the relevant art, however, will recognize that these embodiments can be practiced without one or more of the specific details, or with other components, systems, and so on. In other instances, well-known structures or operations are not shown, or are not described in detail, to avoid obscuring aspects of the disclosed embodiments.

### The User Profile

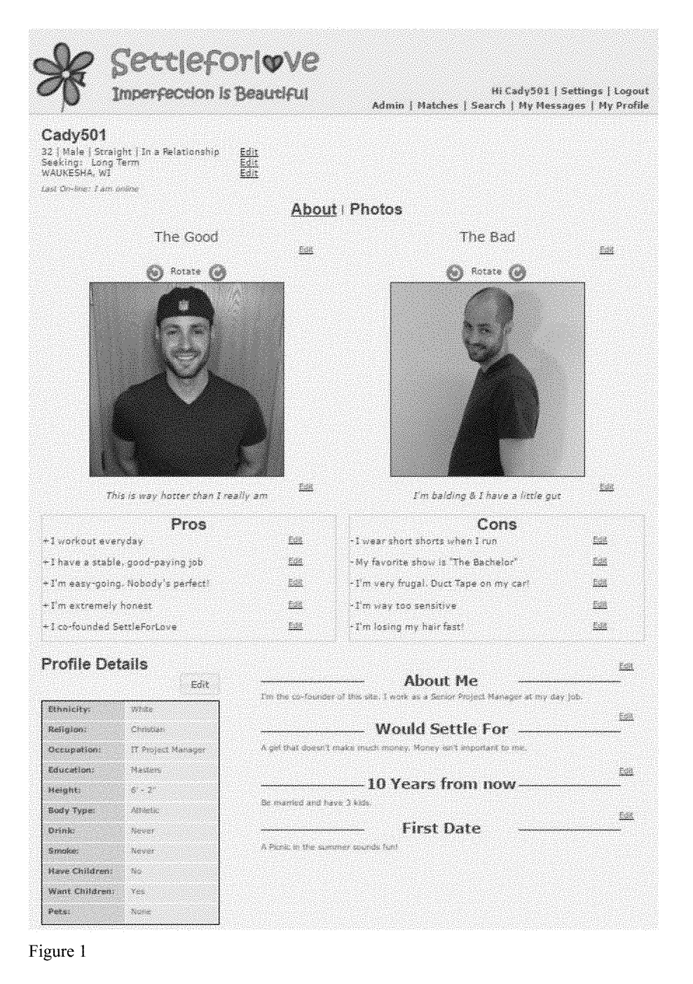

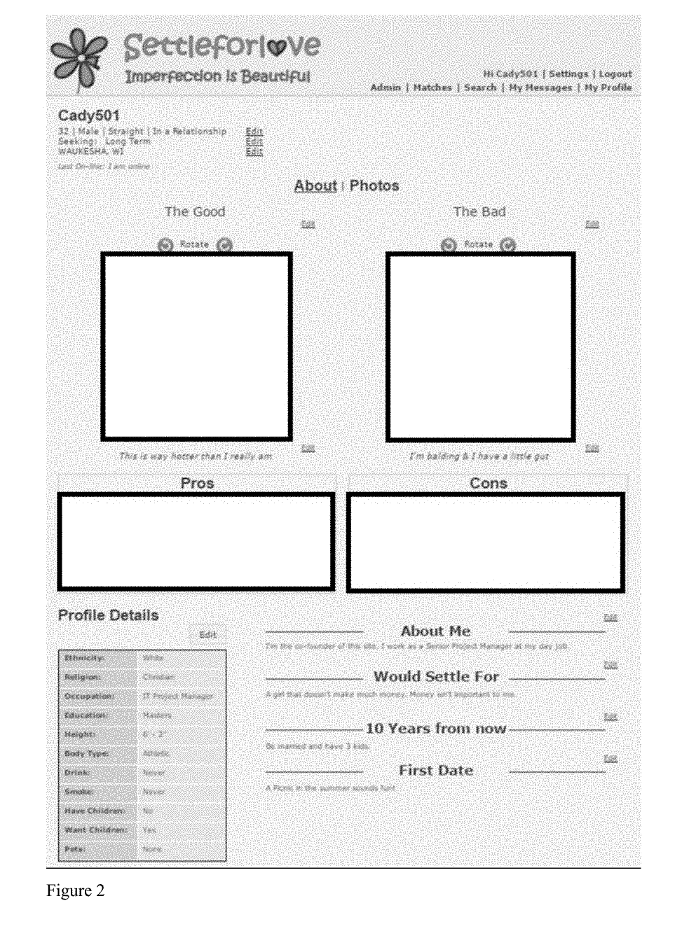

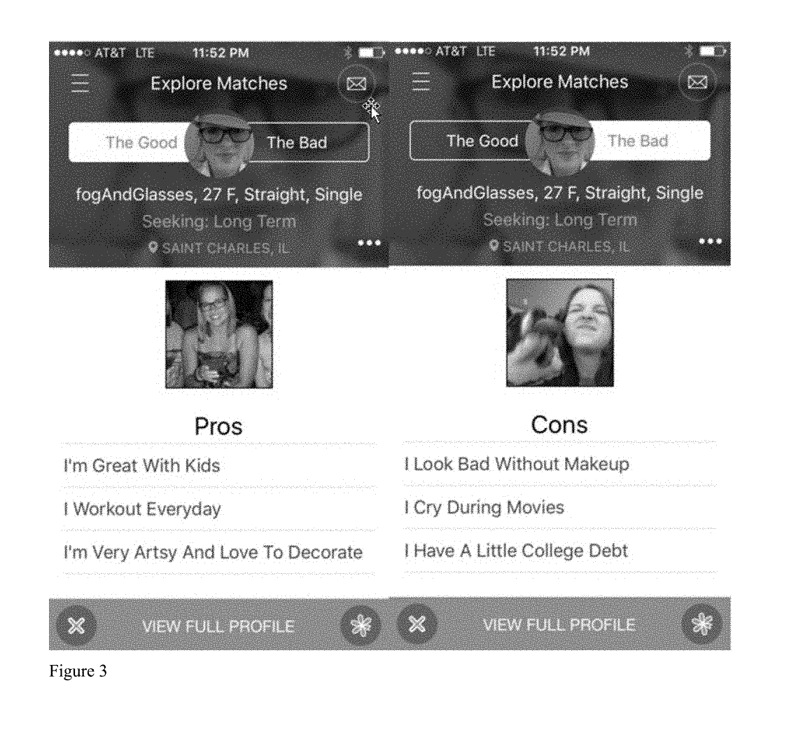

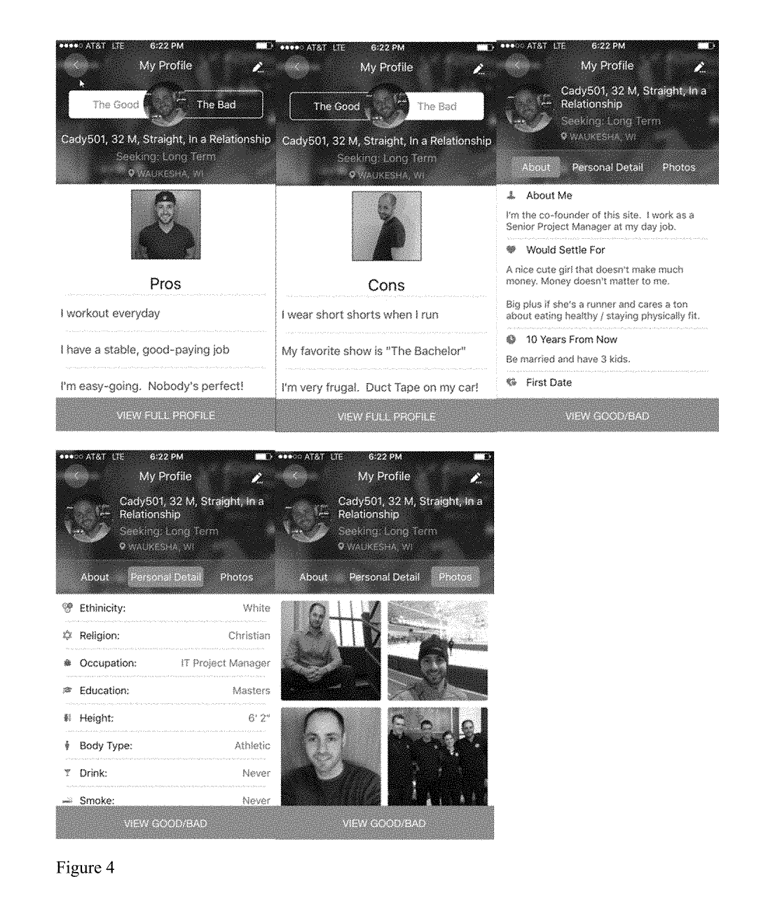

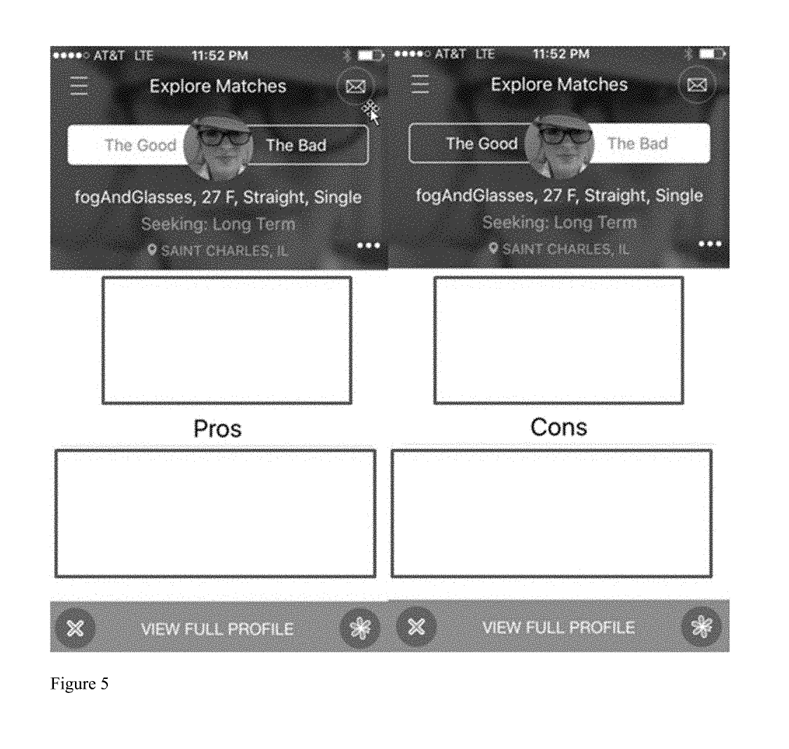

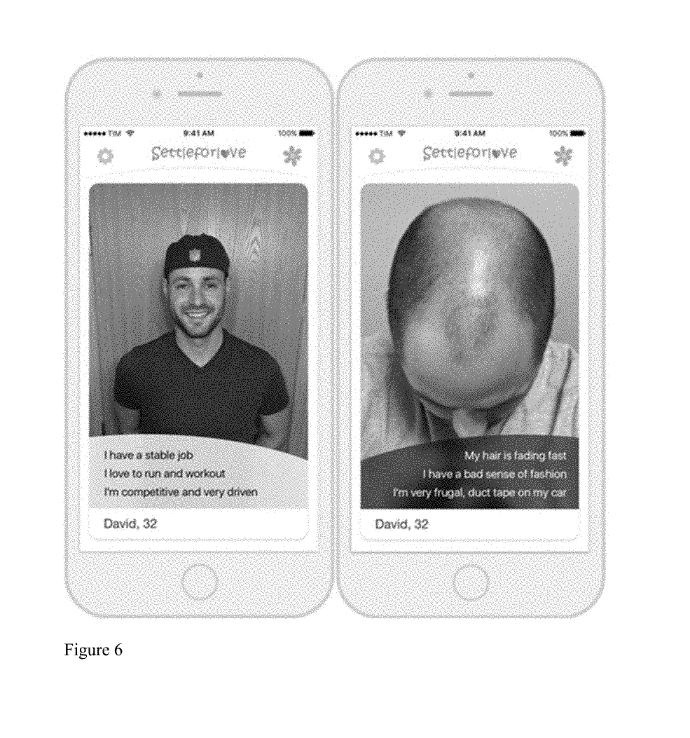

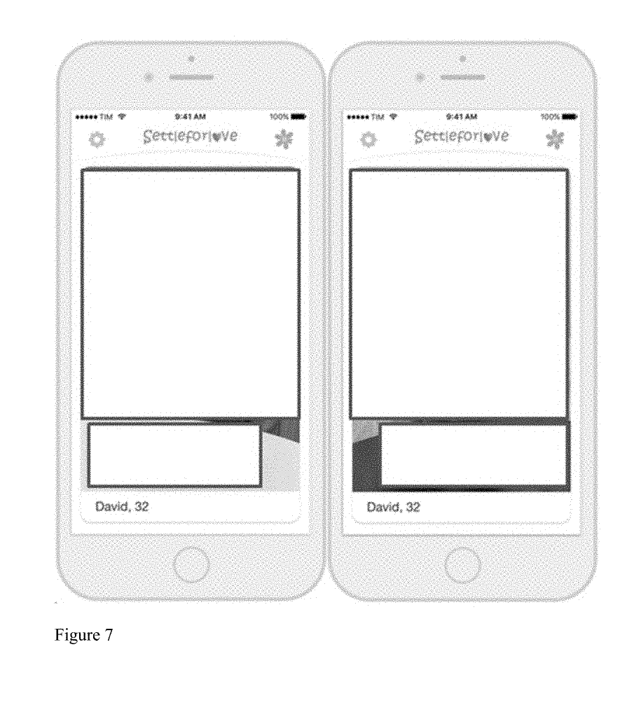

As shown in FIGS. 1-7, the invention comprises a user profile for use in an online dating and social networking system. By “user profile” we mean a description of the user of the system, which may be updated on a periodic basis. The user profile must be completed by the user to participate in the system. The user profile may include the user's name and contact information, and must include at least one negative image, characteristic or description of the user. In alternate embodiments, the user profile may further comprise at least one flattering image, characteristic or description about the user, or any combination of the above. In one embodiment, the user profile consists of at least one negative image of the user. In other embodiments, the user profile consists of at least one negative image of the user and at least one negative characteristic of the user. The user profile may also include additional information, including such things as hopes, dreams, expectations, plans and the like.

By “negative” or “unflattering” we mean any image, characteristic or description that is considered undesirable or bad by the user. Other terms may be used to describe a “negative” or “unflattering” image, characteristic or description, including, for example, “bad,” “harmful”, “adverse”, “damaging”, “detrimental”, “unfavorable”, “disadvantageous”, “undesirable” and the like. A “bad” picture may showcase an imperfection or unattractive quality of the user, such as a photo of the user without any makeup or your typical appearance when lounging around your residence. A negative characteristic or description may include self-identifying as unemployed, still living with their parents, early-onset baldness, compulsive behaviors, other personality flaws, and the like.

By “positive” or “flattering” we mean any image, characteristic that is considered good, affirmative, or constructive by the user. Other terms may be used to describe a “positive” or “flattering” image, characteristic or description, including, for example only, “good”, “favorable”, “beneficial”, “encouraging”, “desirable”, “useful”, “worthwhile” and the like. A “good” picture is a positive or attractive picture intended to attract someone to that profile. Other positives characteristics or descriptions include details about the user's image, lifestyle, job, personality, physical fitness, intelligence, kindness, and the like.

By “picture”, “image”, “characteristic” or “description” we mean any text, photo, picture, selfie, snapshot, image, print, drawing, video, audio or other format that is used to describe any element of the user.

The user profile may also include other fields, including, without limitation and in any combination, an “About Me” field, where a user provides a brief self-summary; a “10 Years From Now” field, where a user's goals and plans in 10 years are identified; or a “First Date” field, where an ideal first date is described. In some embodiments, the user profile may also include some characteristics a user “would settle for” in a potentially compatible user. Typical “Profile Details” can also be provided, including (but not limited to) ethnicity, religion, occupation, education, height, body type, alcohol and cigarette use, and a user's position on children and pets. The ability to contact the user through the system may also be provided.

In contrast to most conventional online dating sites, the user profile must self-identify the “good” and the “bad” about the user. The user profile must include at least one of a “good” and/or “bad” picture, as well as, optionally, identify at least one “good” and/or “bad” characteristics.

The system includes a “Good/Bad” section where the positive and negative image, characteristics or descriptions self-identified by the user are displayed. Other descriptions of the “Good/Bad” section that convey the same meaning are also included in this description, including “Positives/Negatives”, “Perfections/Imperfections”, “Best/Worst”, “Attractive/Unattractive”, “Serious/Goofy”, “Shine/Shade”, “Shine/Shadow”, “Beautiful/Ugly”, “Happy/Sad”, “Pleasant/Unpleasant”, “Perfect/Imperfect”, “Perfect/Realistic”, “Online”/“Real”, “Good-Looking/Bad-Looking” “Pluses/Minuses”, “Strengths/Weaknesses”, “Advantages/Disadvantages”, “Favorable Traits/Unfavorable Traits”, “Favorable/Unfavorable”, “Interests/Hates”, “Likes/Dislikes”, “Likable Traits/Unpleasant Traits”, “Perfections/Imperfections”, “Fantasy/Reality”, “Perfections/Realisms”, “Accomplishments/Disappointments”, “Successes/Failures”, “Wins/Losses”, “Soundness/Faults”, “Merit/Demerits”, “Proficiency/Deficiency”, “Correct/Mistake”, “Successes/Failures”, “Beauty/Blemish” and the like.

In one embodiment, the user profile will not be accepted without at least one bad image or picture and/or at least one negative characteristic or description. However, in other embodiments, a user may elect to only submit at least one “good” image or picture, or only submit at least one “bad” picture, or only submit at least one “pro” or only at least one “con”. In other embodiments a user may be required to submit at least one “good” picture and at least one “bad” picture. Further, in other embodiments of the invention, the submission of a “good”/“bad”, “pros”/“cons” may be optional, and not a requirement. In one embodiment, the user profile may also include a description of what the user is looking for in a “match” (i.e., a compatible user), with the understanding that no one is perfect. Accordingly, the user may identify at least one chacarcteristic the user “Would Settle For” in a date. Essentially, this field allows the user to acknowledge those attributes that are least important to the user (i.e., it's ok if their match lives with their parents, has a lot of college debt, etc.).

### In Use.

The online dating and social networking system of the present invention can be accessed through a website or mobile app. Both provide a platform where users can identify potentially compatible users for romantic or social relationships. In use, a user will join the system by completing a mandatory user profile with at least one negative image, characteristic of description. The process begins with users creating a profile either manually or by importing details from an external website such as, for example, Facebook®. Upon submitting the completed user profile, the system reviews, sorts and identifies potentially compatible users based on the information provided in the user profile. Potentially compatible users can be identified based on multiple criteria, including, for example and without limitation, location, sexual preference, age, and the like.

In one embodiment, once a new user profile is completed, it is compared to existing user profiles to identify any potentially compatible users based on reciprocal compatibility between users. In one embodiment, a match means a user profile that meets a second user's requirements for specific criteria, either professionally, socially or romantically. For instance, matches may be created by comparing a user's specific criteria such as, desired relationship (friend, date, professional contact, etc.); location (within 100 miles of my home, within 5 miles of current GPS location (such as when on vacation)); sexual preference; age; etc.) to other users profiles. Users are informed of any matches through the website or mobile app. Users may have the option to communicate with a match (wink, message them, send them a connection request, etc.), or move onto the next match.

Once a potentially compatible user is identified, the user can evaluate the potentially compatible user's profile and decide whether to move forward or not. In use, the user can “like” the match, “dislike” the match, or otherwise take action to move forward or ignore the identified user. If two users mutually like one another, they may be able to communicate directly with each other using conventional methods known to the art (i.e., text, emails, chat, audio messages, video messages, call, pictures, and the like). Various notifications (phone, email, etc.) may alert a user when other members are taking certain actions such as “viewing their profile”, “messaging them”, or “liking them.”

Users may also have the ability to specify criteria required in any compatible user. For example, it's possible a male user only likes to date other users close to him so he may narrow the match distance to 10 miles instead of 100 or 150 miles. Users also have the ability to edit their profile, changing or adding additional details after the initial registration process. Users can also tweak various user settings such as desired notifications (phone, email, etc.) and the frequency of notifications they would like to receive (instant, daily, weekly, etc.). The website and mobile app of the current invention may include integration with 3^{rd} party applications—like Facebook®, Instagram®, Snapchat®, Yelp® etc., in order to maximize the user's experience. Furthermore, the system will continually be enhanced and changed to create a seamless and positive experience for users.

The currently disclosed system may be searchable and provide “matches” between users based on specific user-based criteria. The site also allows for additional photos and profile details to be added to the user profile over time. The currently disclosed dating site also facilitates communication with a user (including, but not limited to, instant chat, email, messaging, text, audio messages, and video messages).

The system will generate revenue via multiple sources. A subscription service may be introduced that unlocks additional features for those members who pay the subscription fee. This could include, for example and without limitation, ad removal, match priority, notification procedures, etc. Purchases from within the system by users will also generate revenue, such as paying to view additional details or photos of a match, paying to contact a member, paying to see a member's imperfect side, etc. Furthermore, advertising materials may be placed on various versions of the system, thus generating revenue from our non-subscription customers. Other revenue sources could include “date recommendations” which would recommend restaurants, bars, and other forms of dates to those who have been matched or are using the system. In this case, revenue is made from the vendors who are advertising on the website and/or app. These vendors could be added manually, or through third party integration to a company such as Yelp.

### Advantages of the Disclosure

The user profile offers many benefits to conventional online dating and social networking websites and mobile apps. Requiring a more realistic user profile speeds up the dating process by acknowledging up front that everyone has looks and characteristics which can be viewed positively (“pros” or “good”) or negatively (“cons” or “bad”). By requiring users to self-identify those characteristics early in the process instead of later in the relationship, the currently disclosed online dating and social networking site and mobile app encourages deeper real-life discussions so users know sooner if a suggested match is worth pursuing. For instance, User A may only make $15,000 dollars a year working part-time at a local restaurant. User A may list “struggling to put food on the table” as a “con.” User B may not be interested in User A because User B values someone who has more financial security. In this example, User B will avoid contacting User A and save time since it is not a good match. Without this dating and social networking website and app, User A and User B may have talked for months (wasting time) until User A mentioned they make a small annual salary.

With conventional online dating and social networking websites, User C may talk to User D online for weeks, only to finally meet in person and then realize User D looks nothing like their picture. Furthermore, on a traditional dating or social networking website, User C may talk to User D for weeks, finally meet in person, and only then realize that User D is a compulsive nail-biter. By self-identifying up front the pros and cons of each user, the online dating site of the present disclosure allows users to decide up front how much time to invest in a potential “match”.

Further, while a user may self-identify a negative characteristic or trait, another user may not agree. In other words, some “cons” can be attractive! In fact, many people are more attracted to a user's cons than their pros. For example, User A may be attracted to User B's con of, “I hate cooking” because User A wants to do the cooking for the relationship. Cons add diversity that cannot be found on other conventional dating and social networking websites.

Similarly, “bad” pictures can be attractive! For example, User A may be attracted to User B's bad picture which shows him/her looking “heavyset” because User A actually likes heavyset individuals.

Reviewing a user's “bad” pictures and potentially negative “cons” can actually be positive attributes if they are viewed as showing personality, intelligence, and creativity—cons can be attractive to certain users.

In addition, the online dating and social networking website and mobile app of the present disclosure are more fun to use! Traditional dating/social networking sites/apps are all the same, with every user trying to present some mythical “perfect” image to get that “perfect match”. In contrast, the online dating and social networking website and mobile app of the present disclosure gives every user a more interesting, real-life description of potential “matches”, as everyone has very different ideas about what are pros/cons and good/bad pictures. Further, the realistic user profiles of the present disclosure encourage honesty and open communication, which can lead to healthier long-term relationships.

This realism also makes real-life first meetings/dates better because there's so much to talk about! Specifically, the Good/Bad pictures and Pros/Cons drive conversations that simply don't happen on other sites, in a good-humored, fun way. Increased conversation increases online traffic and increased membership, further increasing the chances of meeting that “perfect match.”

Additional embodiments will become readily apparent to those skilled in the art from the following claims. The invention is capable of other and different embodiments, which are to be regarded as illustrative and not restrictive.

We claim:

1. An online dating and social networking system for identifying compatible users to each other, the system comprising:
a. a network of users, wherein each user completes a user profile to be searchable and contactable by other users in the system, wherein the user profile comprises at least one negative image of the user; and
b. a process for identifying compatible users.

2. The online dating and social networking system of claim 1, wherein the user profile further comprises at least one positive image of the user.

3. The online dating and social networking system of claim 1, wherein the user profile further comprises at least one positive characteristic about the user.

4. The online dating and social networking system of claim 1, wherein the user profile of further comprises at least one negative characteristic of the user.

5. The online dating and social networking system of claim 1, wherein the user profile consists of:
a. at least one flattering image of the user;
b. at least one unflattering image of the user;
c. at least one positive characteristic about the user; and
d. at least one negative characteristic of the user.

6. The user profile of claim 5 further comprising at least one image or characteristic the user “would settle for” in a compatible user.

7. A user profile for identifying compatible users online in a dating and social networking system consisting of at least one unflattering image of the user.

8. The user profile of claim 7 further comprising at least one negative characteristic of the user.

9. The user profile of claim 7 further comprising at least one positive image of the user.

10. The user profile of claim 7 further comprising at least one positive characteristic of the user.

11. A method for identifying compatible users of an online dating and social networking system to each other, the method comprising:
a. supporting a network of users;
b. requiring each user to complete a user profile, wherein the user profile comprises:
i. at least one flattering image of the user; or
ii. at least one unflattering image of the user; or
iii. at least one positive characteristic about the user; or
iv. at least one negative characteristic of the user; and
c. identifying compatible users to each other based on the user profile.

12. The method of claim 11, wherein the user profile consists of:
a. at least one unflattering image of the user; or
b. at least one negative characteristic of the user.

13. The method of claim 11, wherein the user profile consists of:
a. at least one unflattering image of the user; and
b. at least one negative characteristic of the user.

14. The method of claim 11, wherein the user profile consists of:
a. an unflattering image of the user;
b. at least one negative characteristic of the user; and
c. at least one positive characteristic of the user.

15. The method of claim 11, wherein the user profile consists of:
i. at least one flattering image of the user;
ii. at least one unflattering image of the user;
iii. at least one positive characteristic about the user; and
iv. at least one negative characteristic of the user

16. An online dating and social networking system for identifying compatible users to each other, the system comprising:
a. a network of users, wherein each user completes a user profile to be searchable and contactable by other users in the system, wherein the user profile comprises at least one negative characteristic of the user; and
b. a process for identifying compatible users.

17. The online dating and social networking system of claim 16, wherein the user profile further comprises at least one positive image of the user.

18. The online dating and social networking system of claim 16, wherein the user profile further comprises at least one positive characteristic about the user.

19. The online dating and social networking system of claim 16, wherein the user profile of further comprises at least one negative image of the user.

20. The online dating and social networking system of claim 16, wherein the user profile consists of:
a. at least one flattering image of the user;
b. at least one unflattering image of the user;
c. at least one positive characteristic about the user; and
d. at least one negative characteristic of the user.
